(19) United States
(12) Patent Application Publication
(10) Pub. No.: US 2018/0086556 A1
(43) Pub. Date: Mar. 29, 2018

(54) Waste Receptacle Storage and Transportation Container

(71) Applicant: Armen Derderian, San Diego, CA (US)

(72) Inventor: Armen Derderian, San Diego, CA (US)

(21) Appl. No.: 15/278,319

(22) Filed: Sep. 28, 2016

(51) Int. Cl. B65F 1/14

(52) U.S. Cl. CPC B65F 1/1468; B65F 2220/101; B65F 2001/1489; B65F 1/141

(57) ABSTRACT

A waste receptacle storage and transportation container is an apparatus utilized to securely hold multiple waste receptacles. The apparatus includes a pallet base, a container frame, and a lateral wall for holding waste receptacles in place on the pallet base. The pallet base enables the apparatus to be lifted via forklift or pallet jack. The apparatus additionally includes a plurality of retaining flanges that enable another instance of the apparatus to be stacked on top of the apparatus. A first support gusset and a second support gusset are utilized to improve structural support of the lateral wall. Waste receptacles within the apparatus are held snug and prevented from shifting by a restraining rail positioned on an interior surface of the lateral wall as well as by a restraining cable that is removably connected across an open end of the apparatus.

### FIELD OF THE INVENTION

The present invention relates generally to a storage and transportation container. More specifically, the present invention is a waste receptacle storage and transportation container that is utilized to securely hold multiple waste receptacles during transportation.

### BACKGROUND OF THE INVENTION

Food and organic waste recycling is becoming increasingly prevalent and organic waste is now viewed as a resource. Food and organic waste recycling has been implemented in a wide variety of venues including residential homes, commercial businesses, events, food processors, schools, hospitals, and airports. Recycled food and organic waste results in renewable energy and compost, benefitting the environment by reducing greenhouse gas emissions, increasing nutrient composition of soil, reducing the amount of waste in landfills, and improving erosion and stormwater control through biofiltration. Restaurant organic recycling focuses on the collection of food waste from fruits, vegetables, meat, poultry, seafood, eggs, milk, juices, plants, coffee grounds, and other food items. The food items are converted into compost, other soil amendments, energy, and other products. The infrastructure required for recycling food and organic waste includes specially designed waste management containers and vehicles. These waste management containers are transported to special facilities where their contents undergo processing.

The present invention is a waste receptacle storage and transportation container that holds and secures multiple waste receptacles during transportation. The present invention is primarily designed for use with organic waste receptacles containing food waste and other organic waste. However, the present invention may be utilized for various other similar applications.

### BRIEF DESCRIPTION OF THE DRAWINGS

FIG. 1 is a front top perspective view of the present invention.

FIG. 2 is a rear top perspective view of the present invention.

FIG. 3 is a front bottom perspective view of the present invention.

FIG. 4 is a rear bottom perspective view of the present invention.

FIG. 5 is a front view of the present invention.

FIG. 6 is a rear view of the present invention.

FIG. 7 is a top view of the present invention.

FIG. 8 is a bottom view of the present invention.

### DETAIL DESCRIPTIONS OF THE INVENTION

All illustrations of the drawings are for the purpose of describing selected versions of the present invention and are not intended to limit the scope of the present invention.

The present invention is a waste receptacle storage and transportation container.

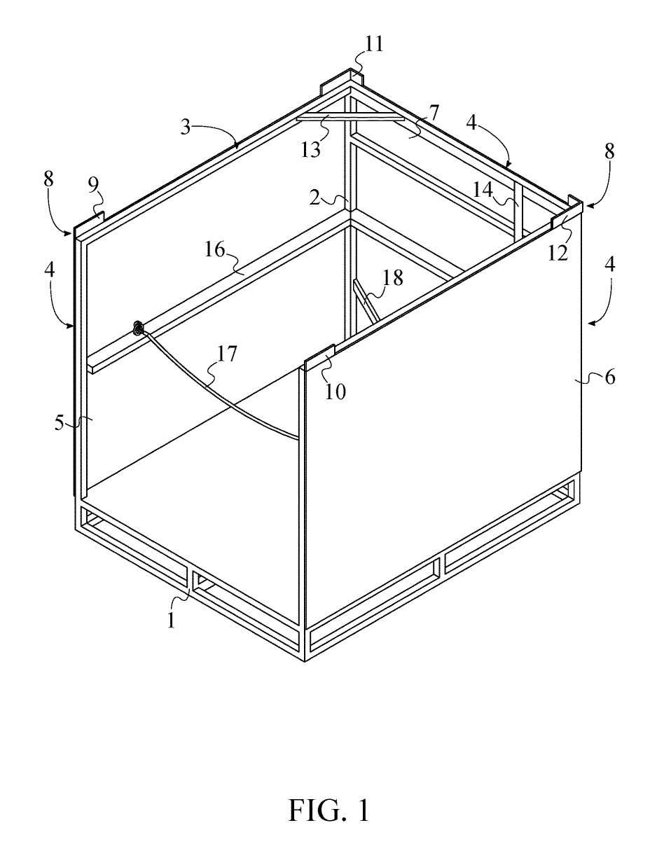

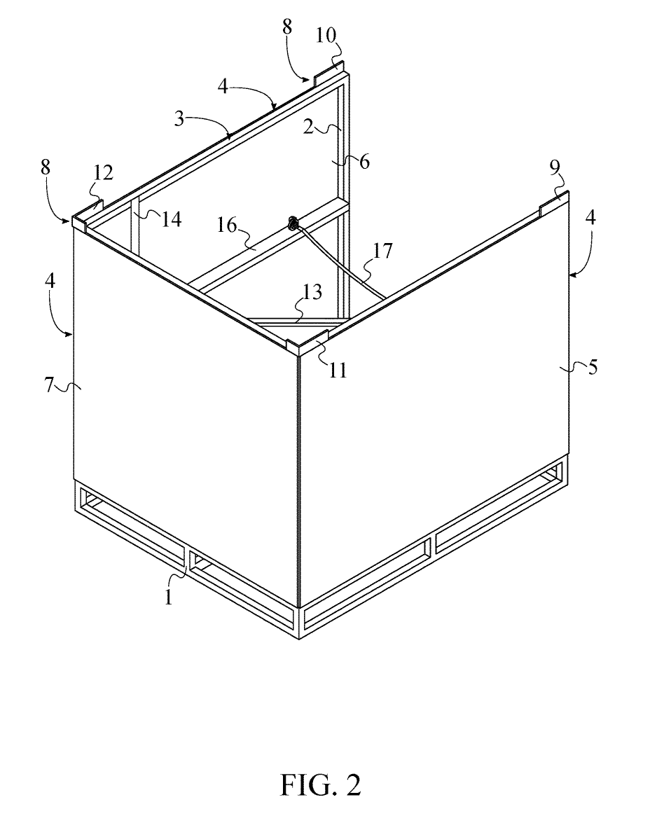

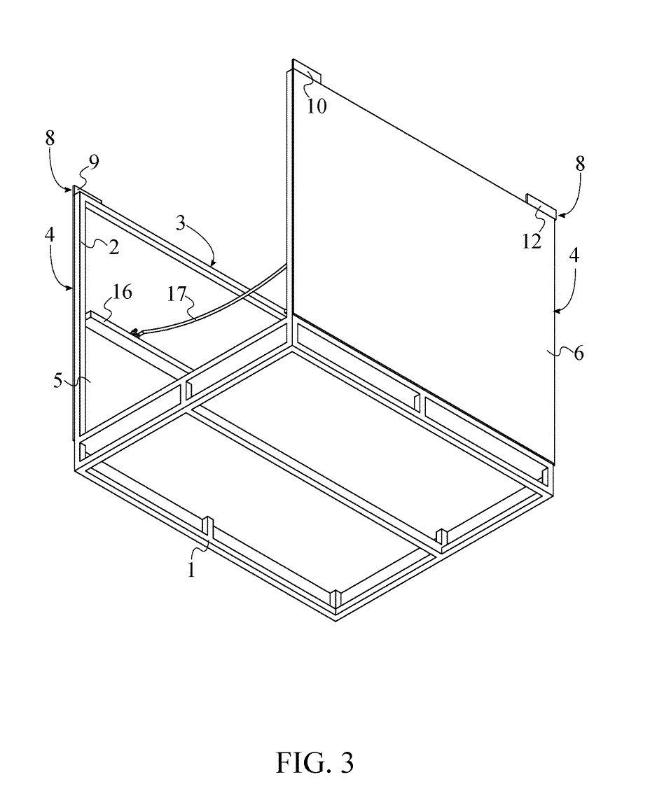

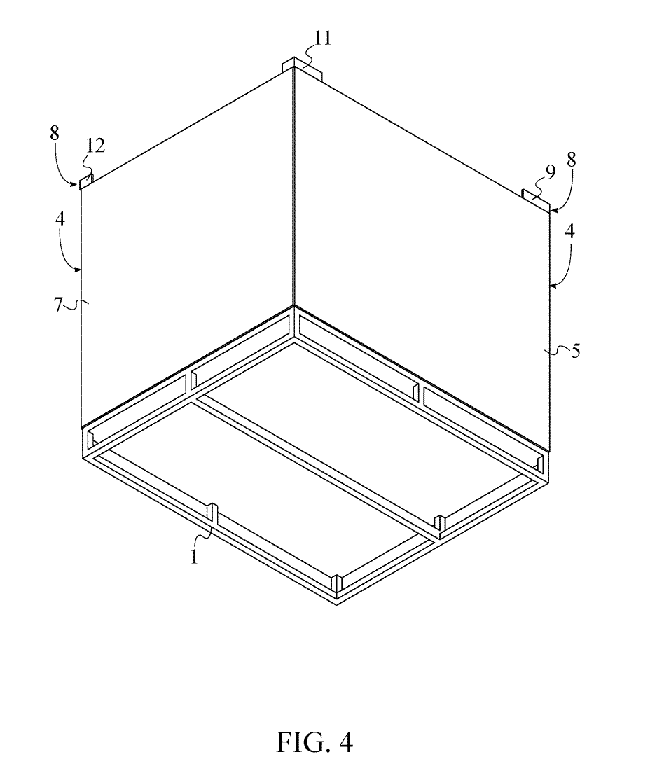

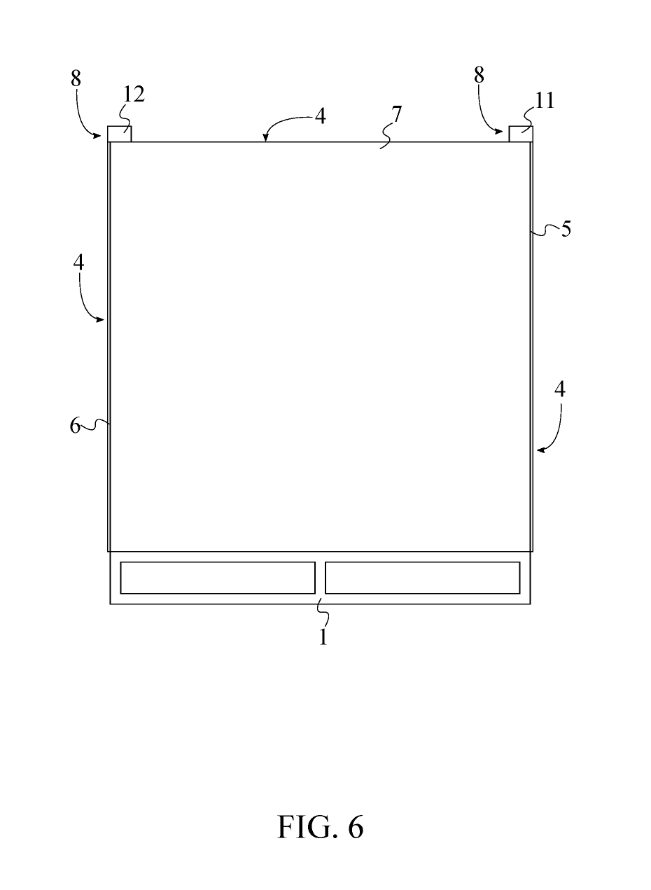

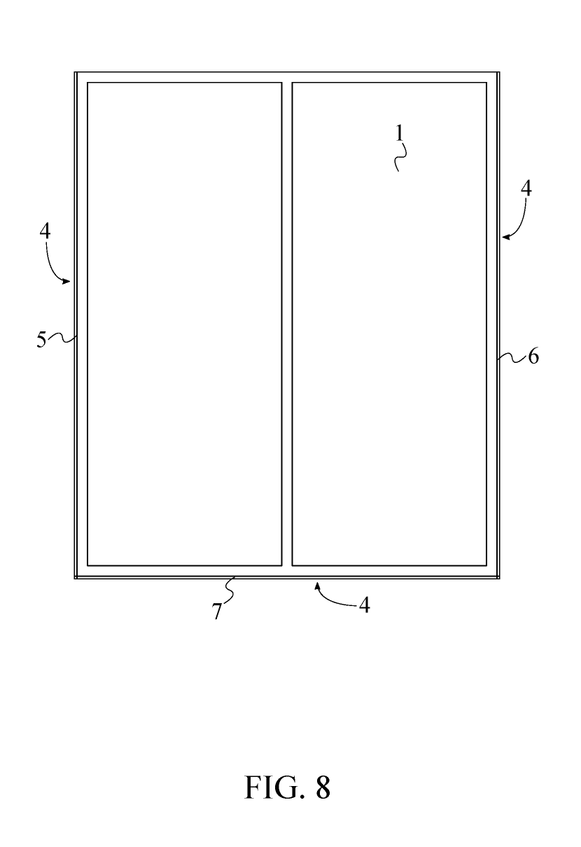

The present invention is designed to store and secure multiple waste receptacles during transportation to a processing facility. The present invention is shown in FIGS. 1-8 and comprises a pallet base 1, a container frame 2, a lateral wall 4, and a plurality of retaining flanges 8.

The pallet base 1 enables the present invention to be lifted and transported via a forklift or pallet jack. The pallet base 1 additionally serves as a base for the present invention. In the preferred embodiment of the present invention, the pallet base 1 is a four-way entry pallet, allowing the present invention to be lifted from all four sides of the pallet base 1. The container frame 2 provides structure to the present invention and serves as a mounting point for the lateral wall 4. The container frame 2 is perimetrically connected about the pallet base, providing a foundation onto which the lateral wall 4 may be mounted.

The lateral wall 4 serves to hold and restrain waste receptacles within the present invention when the present invention is in use. The lateral wall 4 comprises a first wall panel 5, a second wall panel 6, and a third wall panel 7. In the preferred embodiment of the present invention, an open end is present through which waste receptacles may be placed within the lateral wall 4. Additionally, the top of the present invention remains open as well. The lateral wall 4 is laterally connected to the container frame 2. As such, the first wall panel 5, the second wall panel 6, and the third wall panel 7 form three walled sections on the pallet base 1. The first wall panel 5 and the second wall panel 6 are oriented parallel to each other and are positioned on the left side and the right side of the pallet base 1. The third wall panel 7 is terminally connected to the first wall panel 5 and the second wall panel 6 and as such is connected in between the first wall panel 5 and the second wall panel 6. The third wall panel 7 is oriented perpendicular to the first wall panel 5 and the second wall panel 6. In the preferred embodiment of the present invention, the third wall panel 7 is thus positioned on the rear side of the pallet base 1, leaving the front side open to allow waste receptacles to be positioned within the lateral wall 4.

The plurality of retaining flanges 8 is utilized to enable multiple instances of the present invention to be stacked on top of each other. The plurality of retaining flanges 8 is distributed about an upper edge 3 of the container frame 2 and prevents a second instance of the present invention from shifting or becoming unstable when stacked on top of the present invention. The plurality of retaining flanges 8 comprises a first planar flange 9 and a second planar flange 10. The first planar flange 9 and the second planar flange 10 are utilized to brace the first wall panel 5 and the second wall panel 6 of a second instance of the present invention when the second instance of the present invention is stacked on top of the present invention. The first planar flange 9 is connected to the upper edge 3 of the container frame 2, adjacent to the first wall panel 5, while the second planar flange 10 is connected to the upper edge 3 of the container frame 2, adjacent to the second wall panel 6. The first planar flange 9 and the second planar flange 10 are thus able to prevent the second instance of the present invention from falling off of the first wall panel 5 and the second wall panel 6. The first planar flange 9 and the second planar flange 10 are positioned opposite to the third wall panel 7, providing two points of stabilization positioned away from the third wall panel 7.

The plurality of retaining flanges 8 further comprises a first angular flange 11 and a second angular flange 12. The first angular flange 11 and the second angular flange 12 are utilized to brace the first wall panel 5 and the third wall panel 7 as well as the second wall panel 6 and the third wall panel 7 of a second instance of the present invention when the second instance of the present invention is stacked on top of the present invention. The first angular flange 11 is connected to the upper edge 3 of the container frame 2, adjacent to the first wall panel 5 and the third wall panel 7, while the second angular flange 12 is connected to the upper edge 3 of the container frame 2, adjacent to the second wall panel 6 and the third wall panel 7. The first angular flange 11 and the second angular flange 12 are thus able to prevent the second instance of the present invention from falling off of the third wall panel 7. The first angular flange 11 and the second angular flange 12 provide two additional points of stabilization in addition to those provided by the first planar flange 9 and the second planar flange 10.

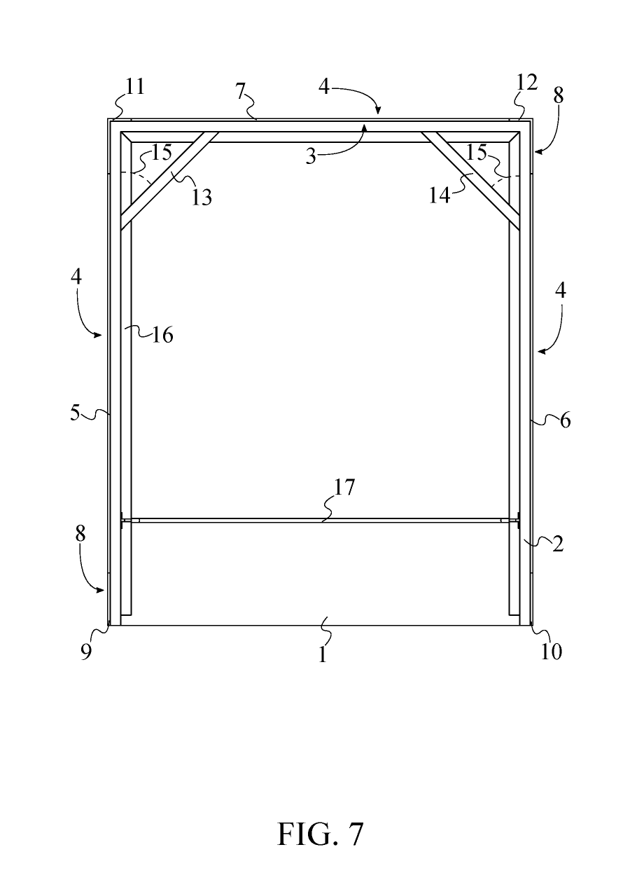

The present invention further comprises a first support gusset 13 and a second support gusset 14. The first support gusset 13 and the second support gusset 14 provide structural support to the container frame 2. The first support gusset 13 is terminally connected to the container frame 2, adjacent to the first wall panel 5 and the third wall panel 7, while the second support gusset 14 is terminally connected to the container frame 2, adjacent to the second wall panel 6 and the third wall panel 7. The first support gusset 13 and the second support gusset 14 thus provide improved structural support to the container frame 2 in the horizontal plane when a second instance of the present invention is stacked on top of the present invention. In the preferred embodiment of the present invention, the first support gusset 13 and the second support gusset 14 are oriented parallel to the pallet base 1. The first support gusset 13 and the second support gusset 14 are thus positioned and oriented in a manner such that waste receptacles may be positioned within the present invention without interference. A second instance of the present invention may additionally be stacked on top of the present invention without interference by the first support gusset 13 and the second support gusset 14. As shown in FIG. 7, the first support gusset 13 and the first wall panel 5 are oriented at a specified angle 15 to each other. Similarly, the second support gusset 14 and the second wall panel 6 are oriented at a specified angle 15 to each other. The angled orientation of the first support gusset 13 and the second support gusset 14 allows the first support gusset 13 and the second support gusset 14 to be positioned in the corners formed by the first wall panel 5 and the third wall panel 7 as well as the second wall panel 6 and the third wall panel 7.

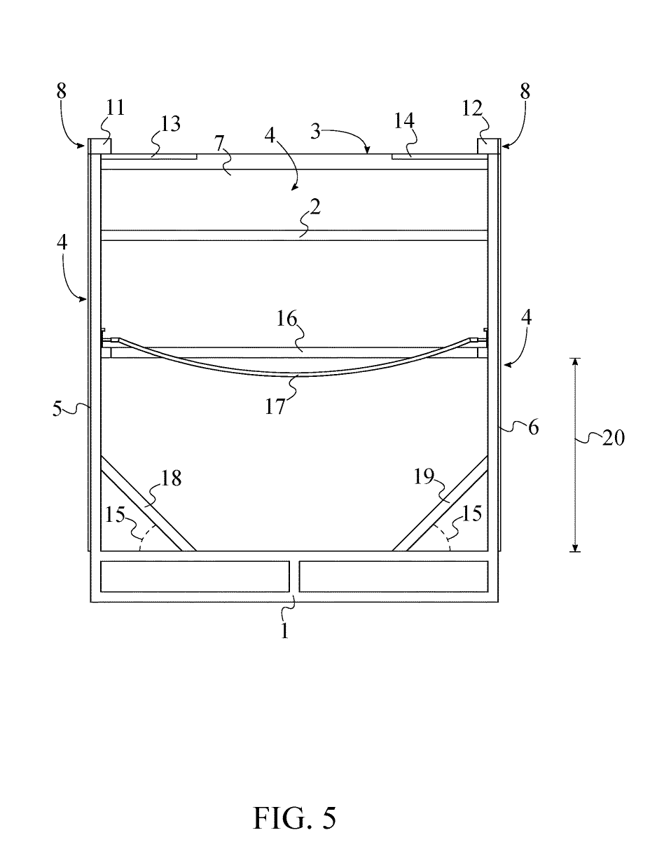

The present invention further comprises a third support gusset 18 and a fourth support gusset 19 that function in a similar manner as the first support gusset 13 and the second support gusset 14. The third support gusset 18 and the fourth support gusset 19 provide additional structural support to the container frame 2. The third support gusset 18 is terminally connected to the container frame 2, adjacent to the third wall panel 7, while the fourth support gusset 19 is terminally connected to the container frame 2, opposite to the third support gusset 18 across the third wall panel 7. The third support gusset 18 and the fourth support gusset 19 thus provide improved structural support to the container frame 2 in the vertical plane when a second instance of the present invention is stacked on top of the present invention. In the preferred embodiment of the present invention, the third support gusset 18 and the fourth support gusset 19 are oriented perpendicular to the pallet base and are thus positioned and oriented in a manner such that the third support gusset 18 and the fourth support gusset 19 do not hinder the placement of waste receptacles within the present invention. As shown in FIG. 5, the third support gusset 18 and the pallet base are oriented at a specified angle 15 to each other. Similarly, the fourth support gusset 19 and the pallet base 1 are oriented at a specified angle 15 to each other. The angled orientation of the third support gusset 18 and the fourth support gusset 19 allows the third support gusset 18 and the fourth support gusset 19 to provide improved structural support for the container frame 2 adjacent to the pallet base 1.

The present invention further comprises a restraining rail 16. The restraining rail 16 is utilized to ensure that waste receptacles within the present invention remain snug and do not shift or otherwise move during use of the present invention. The restraining rail 16 traverses about the container frame 2, adjacent to the first wall panel 5, the second wall panel 6, and the third wall panel 7. The restraining rail 16 is thus placed into contact with the sides of the waste receptacles within the present invention and ensures that the waste receptacles are snug within the lateral wall 4. In the preferred embodiment of the present invention, the restraining rail 16 is oriented parallel to the pallet base 1 and as such remains level across the interior surface. As shown in FIG. 5, the restraining rail 16 is offset from the pallet base 1 by a specified distance 20 to accommodate the tapered design of conventional waste receptacles. The specified distance 20 sufficiently offsets the restraining rail 16 from the pallet base 1 to allow the restraining rail 16 to be placed into contact with the sides of the waste receptacles.

The present invention further comprises a restraining cable 17 that is utilized to prevent waste receptacles within the present invention from being displaced or falling out of the present invention through the open end. The restraining cable 17 along with the restraining rail 16 ensure that the waste receptacles remain snug within the present invention. The restraining cable 17 is removably connected in between the first wall panel 5 and the second wall panel 6, opposite to the third wall panel 7. The restraining cable 17 is thus positioned across the open end of the present invention, preventing movement of the waste receptacles within. The restraining cable 17 may be removed in order to load waste receptacles into the present invention or when removing waste receptacles from the present invention.

Although the present invention has been explained in relation to its preferred embodiment, it is understood that many other possible modifications and variations can be made without departing from the spirit and scope of the present invention as hereinafter claimed.

What is claimed is:

1. A waste receptacle storage and transportation container comprises:
a pallet base;
a container frame;
a lateral wall;
a plurality of retaining flanges;
the lateral wall comprises a first wall panel, a second wall panel, and a third wall panel;
the container frame being perimetrically connected about the pallet base;
the lateral wall being laterally connected to the container frame;
the first wall panel and the second wall panel being oriented parallel to each other;
the third wall panel being terminally connected to the first wall panel and the second wall panel;
the third wall panel being oriented perpendicular to the first wall panel and the second wall panel; and
the plurality of retaining flanges being distributed about an upper edge of the container frame.

2. The waste receptacle storage and transportation container as claimed in claim 1 further comprises:
the plurality of retaining flanges comprises a first planar flange and a second planar flange;
the first planar flange being connected to the upper edge of the container frame, adjacent to the first wall panel;
the second planar flange being connected to the upper edge of the container frame, adjacent to the second wall panel; and
the first planar flange and the second planar flange being positioned opposite to the third wall panel.

3. The waste receptacle storage and transportation container as claimed in claim 1 further comprises:
the plurality of retaining flanges comprises a first angular flange and a second angular flange;
the first angular flange being connected to the upper edge of the container frame, adjacent to the first wall panel and the third wall panel; and
the second angular flange being connected to the upper edge of the container frame, adjacent to the second wall panel the third wall panel.

4. The waste receptacle storage and transportation container as claimed in claim 1 further comprises:
a first support gusset;
a second support gusset;
the first support gusset being terminally connected to the container frame, adjacent to the first wall panel and the third wall panel; and
the second support gusset being terminally connected to the container frame, adjacent to the second wall panel and the third wall panel.

5. The waste receptacle storage and transportation container as claimed in claim 4 further comprises:
the first support gusset and second support gusset being oriented parallel to the pallet base.

6. The waste receptacle storage and transportation container as claimed in claim 4 further comprises:
the first support gusset and the first wall panel being oriented at a specified angle to each other; and
the second support gusset and the second wall panel being oriented at a specified angle to each other.

7. The waste receptacle storage and transportation container as claimed in claim 1 further comprises:
a restraining rail; and
the restraining rail traversing about the container frame, adjacent to the first wall panel, the second wall panel, and the third wall panel.

8. The waste receptacle storage and transportation container as claimed in claim 6 further comprises:
the restraining rail being oriented parallel to the pallet base; and
the restraining rail being offset from the pallet base by a specified distance.

9. The waste receptacle storage and transportation container as claimed in claim 1 further comprises:
a restraining cable; and
the restraining cable being removably connected in between the first wall panel and the second wall panel, opposite to the third wall panel.

10. The waste receptacle storage and transportation container as claimed in claim 1 further comprises:
a third support gusset;
a fourth support gusset;
the third support gusset being terminally connected to the container frame, adjacent to the third wall panel; and
the fourth support gusset being terminally connected to the container frame, opposite to the third support gusset across the third wall panel.

11. The waste receptacle storage and transportation container as claimed in claim 10 further comprises:
the third support gusset and the fourth support gusset being oriented perpendicular to the pallet base.

12. The waste receptacle storage and transportation container as claimed in claim 10 further comprises:
the third support gusset and the pallet base being oriented at a specified angle to each other; and
the fourth support gusset and the pallet base being oriented at a specified angle to each other.

13. The waste receptacle storage and transportation container as claimed in claim 1, wherein the pallet base is a four-way entry pallet.
